(19) United States
(12) Patent Application Publication
(10) Pub. No.: US 2026/0340449 A1
(43) Pub. Date: Oct. 29, 2026

(54) Method of Providing Ongoing Improvement of Draft AI Models

(71) Applicant: SambaNova Systems, Inc., Palo Alto, CA (US)

(72) Inventor: Mohammad A. Gowayyed, Palo Alto, CA (US)

(73) Assignee: SambaNova Systems, Inc., Palo Alto, CA (US)

(21) Appl. No.: 19/190,207

(22) Filed: Apr. 25, 2025

(51) Int. Cl. G06N 5/04

(52) U.S. Cl. CPC G06N 5/04

(57) ABSTRACT

A method for updating a draft model on an artificial intelligence server involves performing inference using the draft model on input data with a sequence of input tokens, to generate predicted output data with predicted output tokens. A main model validates the predicted output data, classifying tokens as either validated or rejected. If any tokens are rejected, the main model determines corrected tokens to replace the rejected ones. The method outputs validated and corrected tokens, and trains the draft model using the difference between corrected and rejected tokens to obtain an updated draft model. This updated model is then deployed to replace the original draft model. If no tokens are rejected, only the validated tokens are outputted. Some implementations include local memory at the neuron level, storing configuration information of both the main model and the draft model, allowing for ongoing improvement of the draft model.

### REFERENCES

The following are incorporated by reference for all purposes: Prabhakar et al., “Plasticine: A Reconfigurable Architecture for Parallel Patterns,” ISCA '17, Jun. 24-28, 2017, Toronto, ON, Canada; and

Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018.

Each publication, patent, and/or patent application mentioned in this specification is herein incorporated by reference in its entirety to the same extent as if each individual publication and/or patent application was specifically and individually indicated to be incorporated by reference.

### BACKGROUND

### Technical Field

The disclosed implementations relate generally to systems and methods used in inferencing artificial intelligence (AI) models.

### Context

Typically, the performance of an AI model on specific hardware may be measured with metrics such as time to first token (e.g., 0.1 seconds); the number of tokens per second (e.g., 30 tokens per second); and the utilization of the hardware (e.g., 10%).

Large models are slow, particularly large language models (LLMs).

### BRIEF DESCRIPTION OF THE DRAWINGS

The technology will be described with reference to the drawings, in which:

FIG. 1 illustrates an example system including a coarse-grained reconfigurable (CGR) processor, a host, and a memory.

FIG. 2 illustrates an example of a computer, including an input device, a processor, a storage device, and an output device.

FIG. 3 illustrates example details of a CGR architecture including a top-level network (TLN) and two CGR arrays.

FIG. 4 illustrates an example CGR array, including an array of CGR units in an array-level network (ALN).

FIG. 5 illustrates an example of a pattern memory unit (PMU) and a pattern compute unit (PCU), which may be combined in a fused compute and memory unit (FCMU).

FIG. 6 is a block diagram of a compiler stack implementation suitable for generating a configuration file for a CGR processor.

FIG. 7 shows an example user program in an example first stage of the compiler stack.

FIG. 8 shows the user program in an example second stage of the compiler stack.

FIG. 9 shows the user program in an example third stage of the compiler stack.

FIG. 10 shows the user program in an example fourth stage of the compiler stack.

FIG. 11 shows the logical computation graph and an example physical layout of the user program.

FIG. 12 illustrates an example system including an AI server operable to run inference on a main model and to perform speculative decoding on a draft model.

FIG. 13 illustrates an example AI server.

FIG. 14 is a flowchart of an example process to train a machine learning model, according to some implementations.

FIG. 15 illustrates a method of using and updating a draft model that performs speculative decoding.

In the figures, like reference numbers may indicate functionally similar elements. The systems and methods illustrated in the figures- and described in the Detailed Description below—may be arranged and designed in a wide variety of different implementations. Neither the figures nor the Detailed Description are intended to limit the scope as claimed. Instead, they merely represent examples of different implementations.

### DETAILED DESCRIPTION

Running inference on a large artificial intelligence model (AI model) can be slow and costly. Implementations reduce the problem by running predictive coding on a smaller model and using the larger model (the main model) to validate the results of the smaller model (the draft model). Validation can be faster and have lower cost than inference itself, so the combination of using the main model and the draft model can be advantageous if the draft model performs reasonably well. Using the validation results, implementations can train and update the draft model either at runtime (i.e., on the fly), automatically when inference volume is low, or on schedule when the inference volume is expected to be low. AI devices with local storage (memory) at the neuron level can store configuration data for both the main model and the draft model, allowing for near-instantaneous switching between the two models and nearly continuous improvement of the draft model.

### TERMINOLOGY

As used herein, the phrase “one of” should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms “comprising” and “consisting” have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. “Coupled to” is generally used in the sense of directly coupled, whereas “coupled with” is generally used in the sense of directly or indirectly coupled. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item can be configured to perform the task even when the unit/circuit/component is not currently on or active. In general, the circuitry that forms the structure corresponding to configured to may include hardware circuits, and may further be controlled by switches, fuses, bond wires, metal masks, firmware, and/or software. Similarly, various items may be described as performing a task or tasks, for convenience in the description. Such descriptions should be interpreted as including the phrase configured to.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B”. This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase based on is thus synonymous with the phrase based at least in part on.

The terms “substantially”, “close”, “approximately”, “near”, and “about” refer to being within minus or plus 10% of an indicated value, unless explicitly specified otherwise.

The following terms or acronyms used herein are defined at least in part as follows:

### ACRONYMS

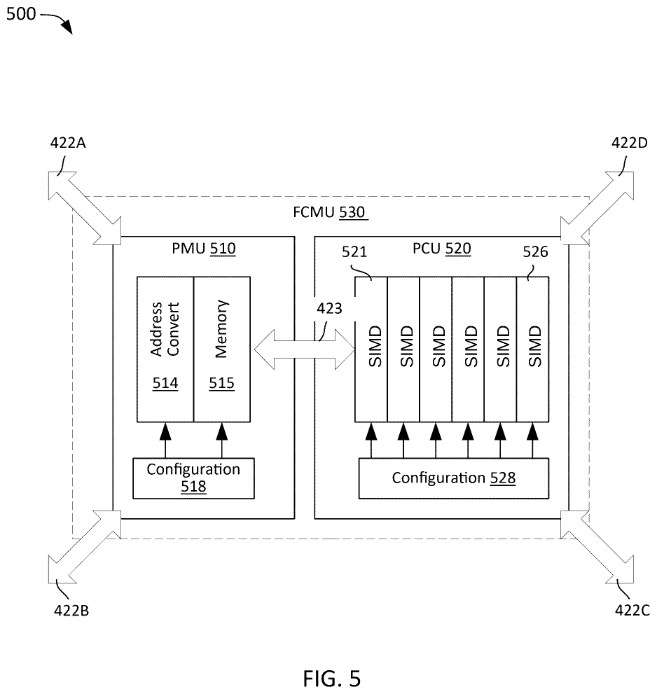

“AGCU”—address generator (AG) and coalescing unit (CU).
“AI”—artificial intelligence.
“AIR”—arithmetic or algebraic intermediate representation.
“ALN”—array-level network.
“Buffer”—an intermediate storage of data.
“CGR”—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.
“CGRA”—coarse-grained reconfigurable architecture. A data processor architecture that includes one or more arrays (CGR arrays) of CGR units.
“Compiler”—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 5.
“Computation graph”—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.
“CGR unit”—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.
“CU”—coalescing unit.
“Dataflow Graph”—a computation graph that includes one or more loops that may be nested, and wherein nodes can send messages to nodes in earlier layers to control the dataflow between the layers.
“Datapath”—a collection of functional units that perform data processing operations. The functional units may include memory, multiplexers, ALUs, SIMDs, multipliers, registers, buses, etc.

“FCMU”—fused compute and memory unit—a circuit that includes both a memory unit and a compute unit.

“Graph”—a collection of nodes connected by edges. Nodes may represent various kinds of items or operations, dependent on the type of graph. Edges may represent relationships, directions, dependencies, etc.

“IC”—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
A “logical CGR array” or “logical CGR unit”—a CGR array or a CGR unit that is physically realizable, but that may not have been assigned to a physical CGR array or to a physical CGR unit on an IC.
“Metapipeline”—a subgraph of a computation graph that includes a producer operator providing its output as an input to a consumer operator to form a pipeline. A metapipeline may be nested within another metapipeline, that is, producer operators and consumer operators may include other metapipelines.
“ML”—machine learning.
“PCU”—pattern compute unit—a compute unit that can be configured to repetitively perform a sequence of operations.
“PEF”—processor-executable format—a file format suitable for configuring a configurable data processor.
“Pipeline”—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the CGR processor, CGR array level, and/or GCR unit level.
“Pipeline Stages”—a pipeline is divided into stages that are coupled with one another to form a pipe topology.
“PMU”—pattern memory unit—a memory unit that can locally store data according to a programmed pattern.
“PNR”—place and route—the assignment of logical CGR units and associated processing/operations to physical CGR units in an array, and the configuration of communication paths between the physical CGR units.
“RAIL”—reconfigurable dataflow unit (RDU) abstract intermediate language.
“CGR Array”—an array of CGR units, coupled with each other through an array-level network (ALN), and coupled with external elements via a top-level network (TLN). A CGR array can physically implement the nodes and edges of a dataflow graph.
“SIMD”—single-instruction multiple-data—an arithmetic logic unit (ALU) that simultaneously performs a single programmable operation on multiple data elements delivering multiple output results.
“TLIR”—template library intermediate representation.
“TLN”—top-level network.

### Implementations

The architecture, configurability and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNext, RCNN, YOLO, SqueezeNet, SegNet, GAN, BERT, ELMo, USE, Transformer, and Transformer-XL.

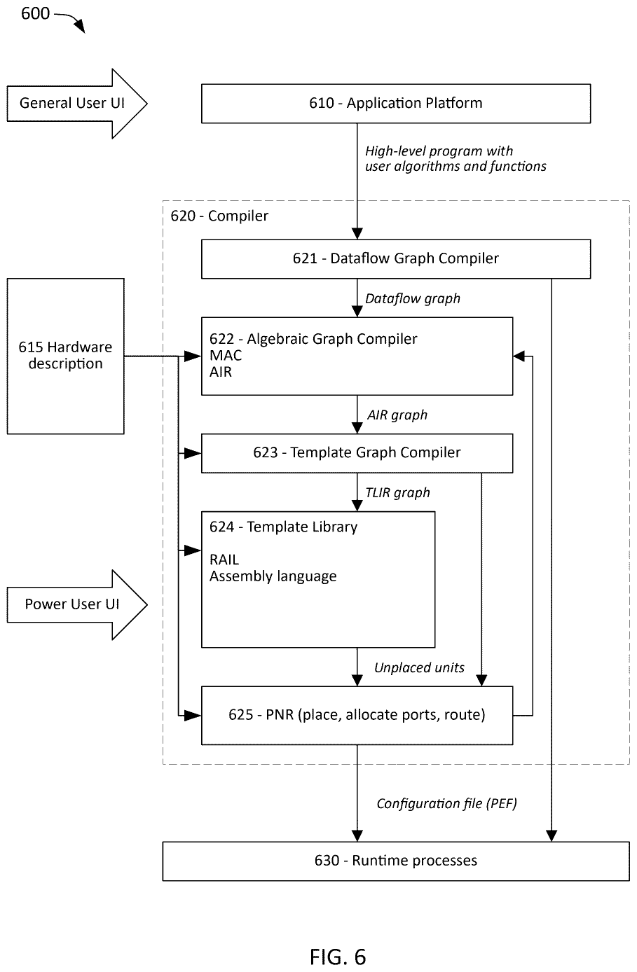

Translation of high-level programs to executable bit files is performed by a compiler, see, for example, FIGS. 6-11. While traditional compilers sequentially map operations to processor instructions, typically without regard to pipeline utilization and duration (a task usually handled by the hardware), an array of CGR units requires mapping operations to processor instructions in both space (for parallelism) and time (for synchronization of interdependent computation graphs or dataflow graphs). This requirement implies that a compiler for a CGRA must decide which operation of a computation graph or dataflow graph is assigned to which of the CGR units, and how both data and, related to the support of dataflow graphs, control information flows among CGR units, and to and from external hosts and storage. This process, known as “place and route”, is one of many new challenges posed to compilers for arrays of CGR units.

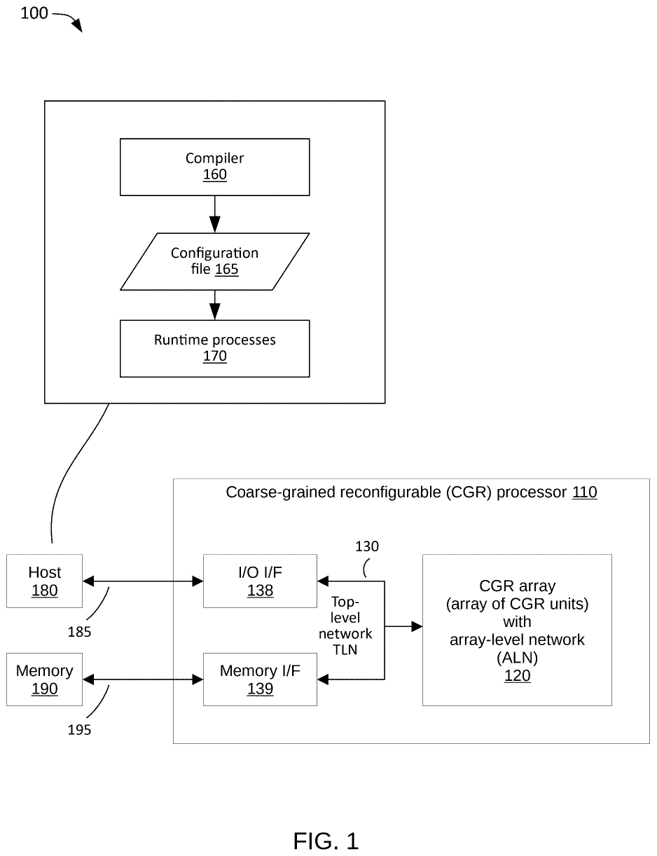

FIG. 1 illustrates an example system 100 including a CGR processor 110, a host 180, and a memory 190. CGR processor 110 has a coarse-grained reconfigurable architecture (CGRA) and includes an array of CGR units 120 such as a CGR array. CGR processor 110 further includes an IO interface 138, and a memory interface 139. Array of CGR units 120 is coupled with IO interface 138 and memory interface 139 via data bus 130 which may be part of a top-level network (TLN). Host 180 communicates with IO interface 138 via system data bus 185, and memory interface 139 communicates with memory 190 via memory bus 195. Array of CGR units 120 may further include compute units and memory units that are connected with an array-level network (ALN) to provide the circuitry for execution of a computation graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of CGR processor 110. In some implementations, CGR processor 110 may include one or more ICs. In other implementations, a single IC may span multiple CGR processors. In further implementations, CGR processor 110 may include one or more units of array of CGR units 120.

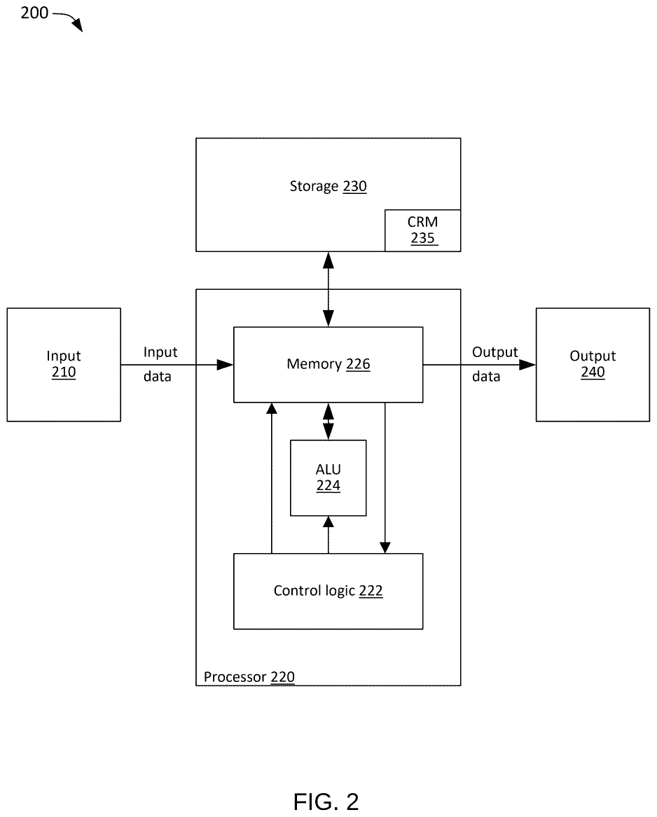

Host 180 may be, or include, a computer such as further described with reference to FIG. 2. Host 180 runs runtime processes, as further referenced herein, and may also be used to run computer programs, such as the compiler 160 further described with reference to FIG. 6. In some implementations, the compiler may run on a computer similar to the computer described with reference to FIG. 2 but separate from host 180.

CGR processor 110 may accomplish computational tasks by executing a configuration file 165 (for example, a PEF file). For the purposes of this description, a configuration file corresponds to a dataflow graph, or a translation of a dataflow graph, and may further include initialization data. A compiler 160 compiles the high-level program to provide the configuration file 165. Runtime processes 170 may install the configuration file 165 in CGR processor 110. In some implementations described herein, a CGR array is configured by programming one or more configuration stores with all or parts of the configuration file 165. A single configuration store may be at the level of the CGR processor 110 or the CGR array 120, or a CGR unit may include an individual configuration store. The configuration file 165 may include configuration data for the CGR array 120 and CGR units in the CGR array 120, and link the computation graph to the CGR array 120. Execution of the configuration file by CGR processor 110 causes the CGR array 120 to implement the user algorithms and functions in the dataflow graph.

CGR processor 110 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 2 illustrates an example of a computer 200, including an input device 210, a processor 220, a storage device 230, and an output device 240. Although the example computer 200 is drawn with a single processor, other implementations may have multiple processors. Input device 210 may comprise a mouse, a keyboard, a sensor, an input port (for example, a universal serial bus (USB) port), and any other input device known in the art. Output device 240 may comprise a monitor, printer, and any other output device known in the art. Furthermore, part or all of input device 210 and output device 240 may be combined in a network interface, such as a Peripheral Component Interconnect Express (PCIe) interface suitable for communicating with CGR processor 110. Input device 210 is coupled with processor 220 to provide input data, which an implementation may store in memory 226. Processor 220 is coupled with output device 240 to provide output data from memory 226 to output device 240. Processor 220 further includes control logic 222, operable to control memory 226 and arithmetic and logic unit (ALU 224), and operable to receive program and configuration data from memory 226. Control logic 222 further controls exchange of data between memory 226 and storage device 230. Memory 226 typically comprises memory with fast access, such as static random-access memory (SRAM), whereas storage device 230 typically comprises memory with slow access, such as dynamic random-access memory (DRAM), flash memory, magnetic disks, optical disks, and any other memory type known in the art. At least a part of the memory in storage device 230 includes a non-transitory computer-readable medium (CRM 235), such as used for storing computer programs.

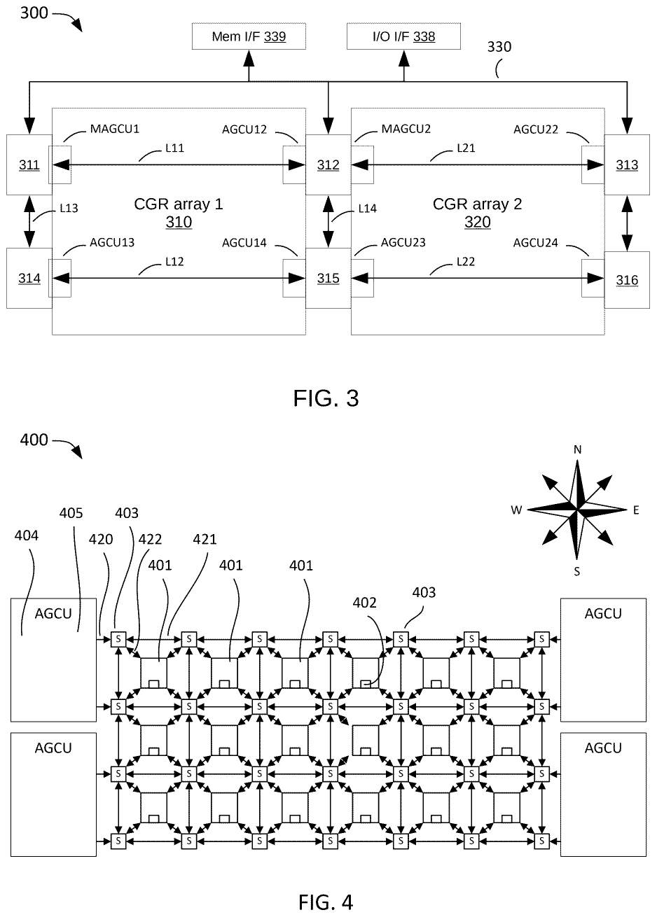

FIG. 3 illustrates example details of a CGR architecture 300 including a top-level network (TLN 330) and two CGR arrays (CGR array 310 and CGR array 320). A CGR array comprises an array of CGR units (e.g., PMUs, PCUs, FCMUs) coupled via an array-level network (ALN), e.g., a bus system. The ALN is coupled with the TLN 330 through several AGCUs, and consequently with I/O interface 338 (or any number of interfaces) and memory interface 339. Other implementations may use different bus or communication architectures.

Circuits on the TLN in this example include one or more external I/O interfaces, including I/O interface 338 and memory interface 339. The interfaces to external devices include circuits for routing data among circuits coupled with the TLN and external devices, such as high-capacity memory, host processors, other CGR processors, FPGA devices, and so on, that are coupled with the interfaces.

Each depicted CGR array has four AGCUs (e.g., MAGCU1, AGCU12, AGCU13, and AGCU14 in CGR array 310). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 310, and MAGCU2 includes a configuration load/unload controller for CGR array 320. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 311, switch 312, switch 313, switch 314, switch 315, and switch 316) coupled with each other as well as with other circuits on the TLN, including the AGCUs, and external I/O interface 338. The TLN includes links (e.g., L11, L12, L21, L22) coupling the top-level switches. Data may travel in packets between the top-level switches on the links, and from the switches to the circuits on the network coupled with the switches. For example, switch 311 and switch 312 are coupled by link L11, switch 314 and switch 315 are coupled by link L12, switch 311 and switch 314 are coupled by link L13, and switch 312 and switch 313 are coupled by link L21. The links can include one or more buses and supporting control lines, including for example a chunk-wide bus (vector bus). For example, the top-level network can include data, request and response channels operable in coordination for transfer of data in any manner known in the art.

FIG. 4 illustrates an example CGR array 400, including an array of CGR units in an ALN. CGR array 400 may include several types of CGR unit 401, such as FCMUs, PMUs, PCUs, memory units, compute units, AGCUs, and/or switches. For examples of the functions of these types of CGR units, see Prabhakar et al., “Plasticine: A Reconfigurable Architecture for Parallel Patterns,” ISCA 2017 Jun. 24-28, 2017, Toronto, ON, Canada. Each of the CGR units may include a configuration store 402 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 401 comprises an FCMU. In other implementations, the array comprises both PMUs and PCUs, or memory units and compute units, arranged in a checkerboard pattern. In yet other implementations, CGR units may be arranged in different patterns. The ALN includes switch units 403 (S), and AGCUs (each including two address generators 405 (AG) and a shared coalescing unit 404 (CU)). Switch units 403 are connected among themselves via interconnects 421 and to a CGR unit 401 with interconnects 422. Switch units 403 may be coupled with address generators 405 via interconnects 420. In some implementations, communication channels can be configured as end-to-end connections, and switch units 403 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 421 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate the destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

A CGR unit 401 may have four ports (as drawn) to interface with switch units 403, or any other number of ports suitable for an ALN. Each port may be suitable for receiving and transmitting data, or a port may be suitable for only receiving or only transmitting data.

A switch unit, as shown in the example of FIG. 4, may have eight interfaces. The North, South, East and West interfaces of a switch unit may be used for links between switch units using interconnects 421. The Northeast, Southeast, Northwest and Southwest interfaces of a switch unit may each be used to make a link with an FCMU, PCU or PMU instance using one of the interconnects 422. Two switch units in each CGR array quadrant have links to an AGCU using interconnects 420. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more links between the switch units to the CGR units using the vector bus and vector interface(s) of the one or more switch units on the ALN. A CGR array may comprise at least a part of CGR array 400, and any number of other CGR arrays coupled with CGR array 400.

A data processing operation implemented by CGR array configuration may comprise multiple graphs or subgraphs specifying data processing operations that are distributed among and executed by corresponding CGR units (e.g., FCMUs, PMUs, PCUs, AGs, and CUs).

FIG. 5 illustrates an example 500 of a PMU 510 and a PCU 520, which may be combined in an FCMU 530. PMU 510 may be directly coupled to PCU 520, or optionally via one or more ALN links 423, or optionally via links through one or more switches. The FCMU 530 may include multiple ALN links, such as northwest ALN link 422A and southwest ALN link 422B, which may connect to PMU 510, and southeast ALN link 422C and northeast ALN link 422D, which may connect to PCU 520. The northwest ALN link 422A, southwest ALN link 422B, southeast ALN link 422C, and northeast ALN link 422D connect to switches 403 as shown in FIG. 4. Each ALN link 422A-D, and ALN link 423 may include one or more scalar links, one or more vector links, and one or more control links where an individual link may be unidirectional into FCMU 530, unidirectional out of FCMU 530 or bidirectional. FCMU 530 can include FIFOs to buffer data entering and/or leaving the FCMU 530 on the links.

PMU 510 may include an address converter 514, a scratchpad memory 515, and a configuration store 518. Configuration store 518 may be loaded, for example from a program running on host 180 as shown in FIG. 1, and can configure address converter 514 to generate or convert address information for scratchpad memory 515 based on data received through one or more of the ALN links 422, and/or ALN link 423. Data received through ALN links 422, and/or ALN link 423 may be written into scratchpad memory 515 at addresses provided by address converter 514. Data read from scratchpad memory 515 at addresses provided by address converter 514 may be sent out on one or more of the ALN links 422, and/or ALN link 423.

PCU 520 includes two or more processor stages, such as SIMD 521 through SIMD 526, and configuration store 528. The processor stages may include ALUs, or SIMDs, as drawn, or any other reconfigurable stages that can process data. PCU 520 may receive data through ALN links 422, and/or ALN link 423, and process the data in the two or more processor stages or store the data in configuration store 528. PCU 520 may produce data in the two or more processor stages and transmit the produced data through one or more of the ALN links 422, and/or ALN link 423. If the two or more processor stages include SIMDs, then the SIMDs may have the same number of processing lanes as the number of data lanes provided by a vector interconnect of ALN links 422, and/or ALN link 423.

Each stage in PCU 520 may also hold one or more registers (not drawn) for short-term storage of parameters. Short-term storage, for example during one to several clock cycles or unit delays, allows for synchronization of data in the PCU pipeline.

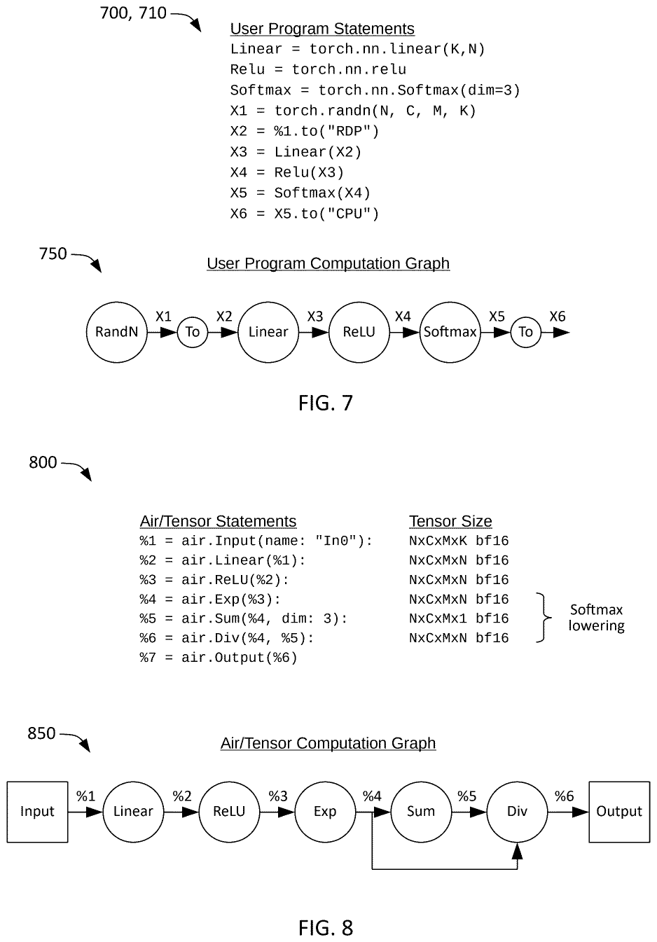

FIG. 6 is a block diagram of a compiler stack 600 implementation suitable for generating a configuration file for a CGR processor. FIGS. 7-11 illustrate various representations of an example user program 700 corresponding to various stages of a compiler stack such as compiler stack 600. As depicted, compiler stack 600 includes several stages to convert a high-level program (e.g., user program 700) with statements 710 that define user algorithms and functions, e.g., algebraic expressions and functions, to configuration data for the CGR units. The example user program 700 depicted in FIG. 7 comprises statements 710 that invoke various PyTorch functions.

Compiler stack 600 may take its input from application platform 610, or any other source of high-level program statements suitable for parallel processing, which provides a user interface for general users. It may further receive hardware description 615, for example defining the physical units in a reconfigurable data processor or CGRA processor. Application platform 610 may include libraries such as PyTorch, TensorFlow, ONNX, Caffe, and Keras to provide user-selected and configured algorithms.

Application platform 610 outputs a high-level program to compiler 620, which in turn outputs a configuration file to the reconfigurable data processor or CGRA processor where it is executed in runtime processes 630. Compiler 620 may include dataflow graph compiler 621, which may handle a dataflow graph, algebraic graph compiler 622, template graph compiler 623, template library 624, and placer and router PNR 625. In some implementations, template library 624 includes RDU abstract intermediate language (RAIL) and/or assembly language interfaces for power users.

Dataflow graph compiler 621 converts the high-level program with user algorithms and functions from application platform 610 to one or more dataflow graphs. The high-level program may be suitable for parallel processing, and therefore parts of the nodes of the dataflow graphs may be intrinsically parallel unless an edge in the graph indicates a dependency. Dataflow graph compiler 621 may provide code optimization steps like false data dependency elimination, dead-code elimination, and constant folding. The dataflow graphs encode the data and control dependencies of the high-level program. Dataflow graph compiler 621 may support programming a reconfigurable data processor at higher or lower-level programming languages, for example from an application platform 610 to C++ and assembly language. In some implementations, dataflow graph compiler 621 allows programmers to provide code that runs directly on the reconfigurable data processor. In other implementations, dataflow graph compiler 621 provides one or more libraries that include predefined functions like linear algebra operations, element-wise tensor operations, non-linearities, and reductions required for creating, executing, and profiling the dataflow graphs on the reconfigurable processors. dataflow graph compiler 621 may provide an application programming interface (API) to enhance functionality available via the application platform 610.

FIG. 7 shows an example user program 700 in an example first stage of the compiler stack. user program 700 generates a random tensor X1 with a normal distribution in the RandN node. It provides the tensor to a neural network cell that performs a weighing function (in the Linear node) followed by a rectified linear unit (ReLU) activation function, which is followed by a Softmax activation function, for example to normalize the output to a probability distribution over a predicted output class. FIG. 7 does not show the weights and bias used for the weighing function. User program 700 corresponds with computation graph 750.

Algebraic graph compiler 622 may include a model analyzer and compiler (MAC) level that makes high-level mapping decisions for (sub-graphs of the) dataflow graph based on hardware constraints. It may support various application frontends such as Samba, JAX, and TensorFlow/HLO. Algebraic graph compiler 622 may also transform the graphs via autodiff and GradNorm, perform stitching between sub-graphs, interface with template generators for performance and latency estimation, convert dataflow graph operations to AIR operation, perform tiling, sharding (database partitioning) and other operations, and model or estimate the parallelism that can be achieved on the dataflow graphs.

Algebraic graph compiler 622 may further include an arithmetic or algebraic intermediate representation (AIR) level that translates high-level graph and mapping decisions provided by the MAC level into explicit AIR/Tensor statements 800 (see FIG. 8) and one or more corresponding algebraic graphs 850. Key responsibilities of the AIR level include legalizing the graph and mapping decisions of the MAC, expanding data parallel, tiling, metapipe, region instructions provided by the MAC, inserting stage buffers and skip buffers, eliminating redundant operations, buffers and sections, and optimizing for resource use, latency, and throughput.

FIG. 8 shows the user program 700 in an example second stage of the compiler stack. At this stage, the algebraic graph compiler replaces the Softmax macro by its constituents. The Softmax function is given as:

$$\frac{{e}^{\{ {z}_{i} \}}}{{\sum }_{j = 1}^{K} {e}^{\{ {z}_{j} \}}} .$$

This function includes an exponential component, a summation, and a division. Thus, algebraic graph compiler 622 replaces the user program statements 710, also shown as computation graph 750, by AIR/Tensor statements 800, also shown as Air/Tensor computation graph 850.

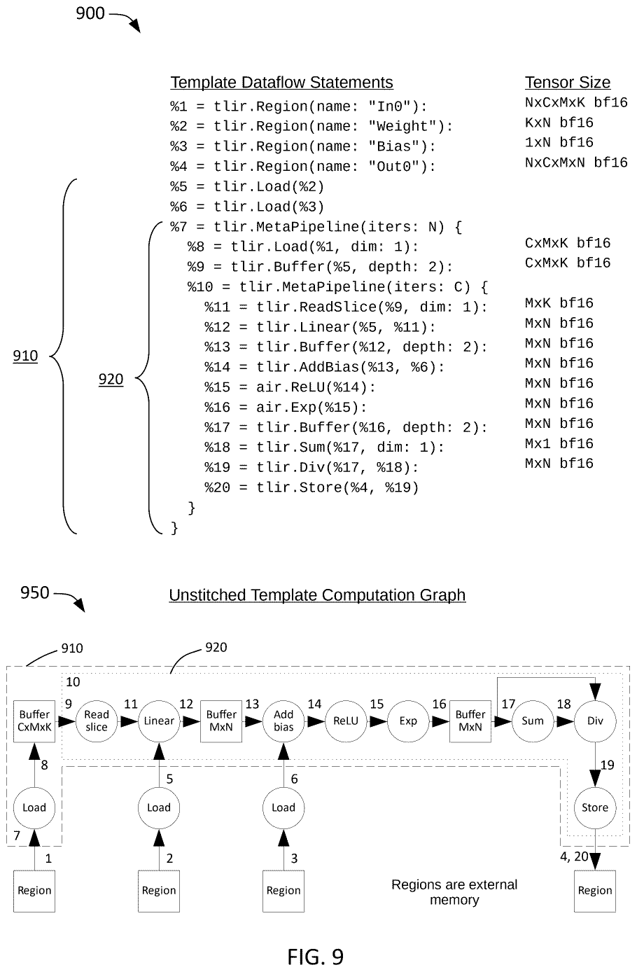

Template graph compiler 623 may translate AIR statements and/or graphs into TLIR statements 900 (see FIG. 9) and/or graphs (graph 950 is shown), optimizing for the target hardware architecture into unplaced variable-sized units (referred to as logical CGR units) suitable for PNR 625. Template graph compiler 623 may allocate metapipelines, such as metapipeline 910 and metapipeline 920, for sections of the template dataflow statements 900 and corresponding sections of unstitched template computation graph 950. Template graph compiler 623 may add further information (name, inputs, input names and dataflow description) for PNR 625 and make the graph physically realizable through each performed step. Template graph compiler 623 may for example provide translation of AIR graphs to specific model operation templates such as for general matrix multiplication (GeMM). An implementation may convert part or all intermediate representation operations to templates, stitch templates into the dataflow and control flow, insert necessary buffers and layout transforms, generate test data and optimize for hardware use, latency, and throughput.

Implementations may use templates for common operations. Templates may be implemented using assembly language, RAIL, or similar. RAIL is comparable to assembly language in that memory units and compute units are separately programmed, but it can provide a higher level of abstraction and compiler intelligence via a concise performance-oriented domain-specific language for CGR array templates. RAIL enables template writers and external power users to control interactions between logical compute units and memory units with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs).

Template library 624 may include an assembler that provides an architecture-independent low-level programming interface as well as optimization and code generation for the target hardware. Responsibilities of the assembler may include address expression compilation, intra-unit resource allocation and management, making a template graph physically realizable with target-specific rules, low-level architecture-specific transformations and optimizations, and architecture-specific code generation.

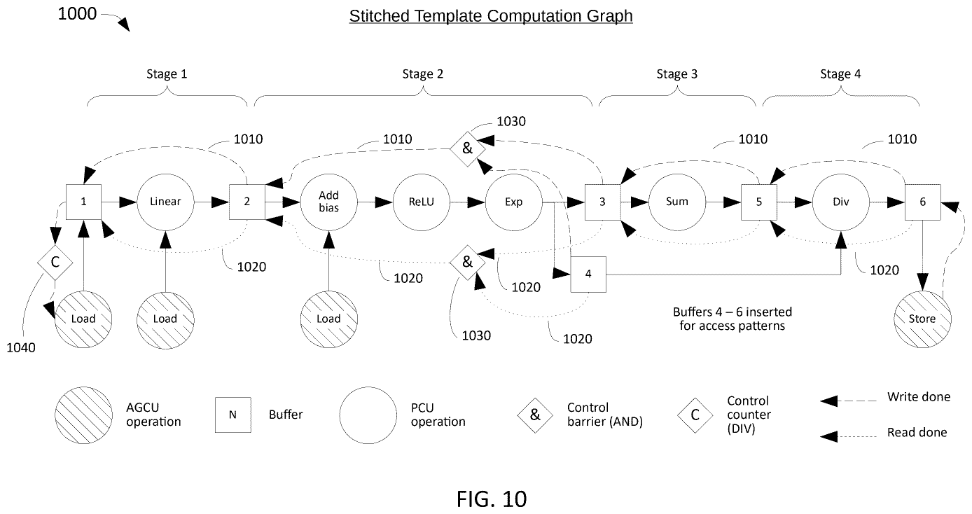

FIG. 10 shows the user program 700 in an example fourth stage of the compiler stack. The template graph compiler 623 may also determine the control signals 1010 and control signals 1020, as well as control gates 1030 and control gates 1040 required to enable the CGR units (whether logical or physical) to coordinate dataflow between the CGR units in the CGR array of a CGR processor. This process, sometimes referred to as stitching, produces a stitched template compute graph 1000 with control signals 1010 to 1020 and control gates 1030 to 1040. In the example depicted in FIG. 10, the control signals include write done signals 1010 and read done signals 1020, and the control gates include ‘AND’ gates 1030 and a counting or ‘DIV’ gate 1040. The control signals and control gates enable coordinated dataflow between the configurable units of CGR processors such as compute units, memory units, and AGCUs.

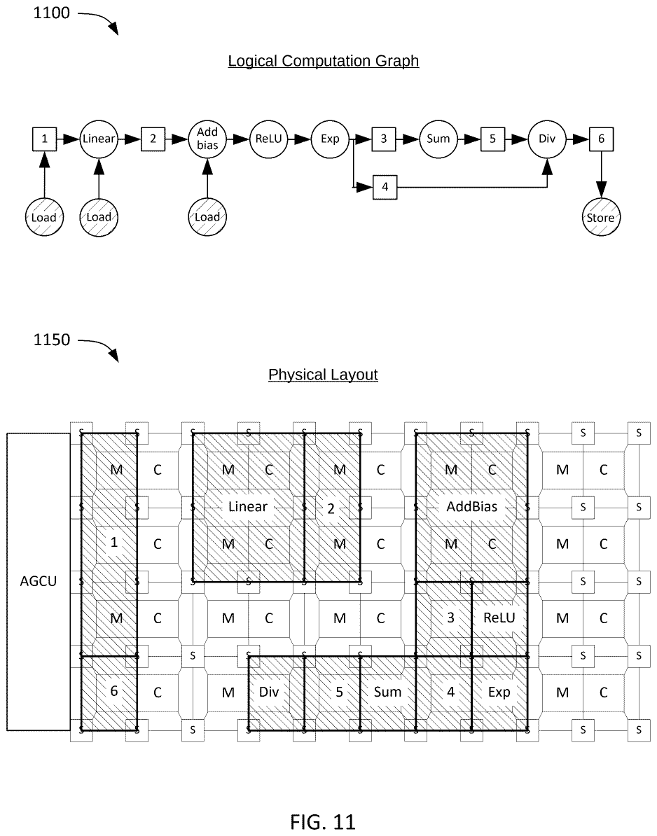

PNR 625 translates and maps logical (i.e., unplaced physically realizable) CGR units (e.g., the nodes of the logical computation graph 1100 shown in FIG. 11) to a physical layout (e.g., the physical layout 1150 shown in FIG. 11) on the physical level, e.g., a physical array of CGR units in a semiconductor chip. PNR 625 also determines physical data channels to enable communication among the CGR units and between the CGR units and circuits coupled via the TLN; allocates ports on the CGR units and switches; provides configuration data and initialization data for the target hardware; and produces configuration files, e.g., processor-executable format (PEF) files. It may further provide bandwidth calculations, allocate network interfaces such as AGCUs and virtual address generators (VAGs), provide configuration data that allows AGCUs and/or VAGs to perform address translation, and control ALN switches and data routing. PNR 625 may provide its functionality in multiple steps and may include multiple modules (not shown in FIG. 6) to provide the multiple steps, e.g., a placer, a router, a port allocator, and a PEF file generator. PNR 625 may receive its input data in various ways. For example, it may receive parts of its input data from any of the earlier modules (dataflow graph compiler 621, algebraic graph compiler 622, template graph compiler 623, and/or template library 624). In some implementations, an earlier module, such as template graph compiler 623, may have the task of preparing all information for PNR 625 and no other units provide PNR input data directly.

Further implementations of compiler 620 provide for an iterative process, for example by feeding information from PNR 625 back to an earlier module, so that the earlier module can execute a new compilation step in which it uses physically realized results rather than estimates of or placeholders for physically realizable circuits. For example, PNR 625 may feed information regarding the physically realized circuits back to algebraic graph compiler 622.

Memory allocations represent the creation of logical memory spaces in on-chip and/or off-chip memories for data required to implement the dataflow graph, and these memory allocations are specified in the configuration file. Memory allocations define the type and the number of hardware circuits (functional units, storage, or connectivity components). Main memory (e.g., DRAM) may be off-chip memory, and scratchpad memory (e.g., SRAM) is on-chip memory inside a CGR array. Other memory types for which the memory allocations can be made for various access patterns and layouts include cache, read-only look-up tables (LUTs), serial memories (e.g., FIFOs), and register files.

Compiler 620 binds memory allocations to unplaced memory units and binds operations specified by operation nodes in the dataflow graph to unplaced compute units, and these bindings may be specified in the configuration data. In some implementations, compiler 620 partitions parts of a dataflow graph into memory subgraphs and compute subgraphs and specifies these subgraphs in the PEF file. A memory subgraph may comprise address calculations leading up to memory access. A compute subgraph may comprise all other operations in the parent graph. In one implementation, a parent graph is broken up into multiple memory subgraphs and exactly one compute subgraph. A single parent graph can produce one or more memory subgraphs, depending on how many memory accesses exist in the original loop body. In cases where the same memory addressing logic is shared across multiple memory accesses, address calculation may be duplicated to create multiple memory subgraphs from the same parent graph.

Compiler 620 generates the configuration files with configuration data (e.g., a bit stream) for the placed positions and the routed data and control networks. In one implementation, this includes assigning coordinates and communication resources of the physical CGR units by placing and routing unplaced units onto the array of CGR units while maximizing bandwidth and minimizing latency.

FIG. 11 shows the logical computation graph 1100 and an example physical layout 1150 of the user program.

A first example of accelerated deep learning is using a deep learning accelerator implemented in a CGRA to train a neural network. A second example of accelerated deep learning is using the deep learning accelerator to operate a trained neural network to perform inferences. A third example of accelerated deep learning is using the deep learning accelerator to train a neural network and subsequently perform inference with any one or more of the trained neural network, information from the trained neural network, and a variant of the same.

Examples of neural networks include fully connected neural networks (FCNNs), recurrent neural networks (RNNs), graph neural networks (GNNs), convolutional neural networks (CNNs), graph convolutional networks (GCNs), long short-term memory (LSTM) networks, autoencoders, deep belief networks, and generative adversarial networks (GANs).

An example of training a neural network is determining one or more weights associated with the neural network, such as by back-propagation in a deep learning accelerator. An example of making an inference is using a trained neural network to compute results by processing input data using the weights associated with the trained neural network. As used herein, the term ‘weight’ is an example of a ‘parameter’ as used in various forms of neural network processing. For example, some neural network learning is directed to determining parameters (e.g., through back-propagation) that are usable for performing neural network inferences.

A neural network processes data according to a dataflow graph comprising layers of neurons. Example layers of neurons include input layers, hidden layers, and output layers. Stimuli (e.g., input data) are received by an input layer of neurons and the computed results of the dataflow graph (e.g., output data) are provided by an output layer of neurons. Example hidden layers include rectified linear unit (ReLU) layers, fully connected layers, recurrent layers, graphical network layers, long short-term memory layers, convolutional layers, kernel layers, dropout layers, and pooling layers. A neural network may be conditionally and/or selectively trained. After being trained, a neural network may be conditionally and/or selectively used for inference.

Examples of ICs, or parts of ICs, that may be used as deep learning accelerators, are processors such as central processing unit (CPUs), CGR processor ICs, graphics processing units (GPUS), FPGAS, ASICs, application-specific instruction-set processor (ASIP), and digital signal processors (DSPs). The disclosed technology implements efficient distributed computing by allowing an array of accelerators (e.g., reconfigurable processors) attached to separate hosts to directly communicate with each other via buffers.

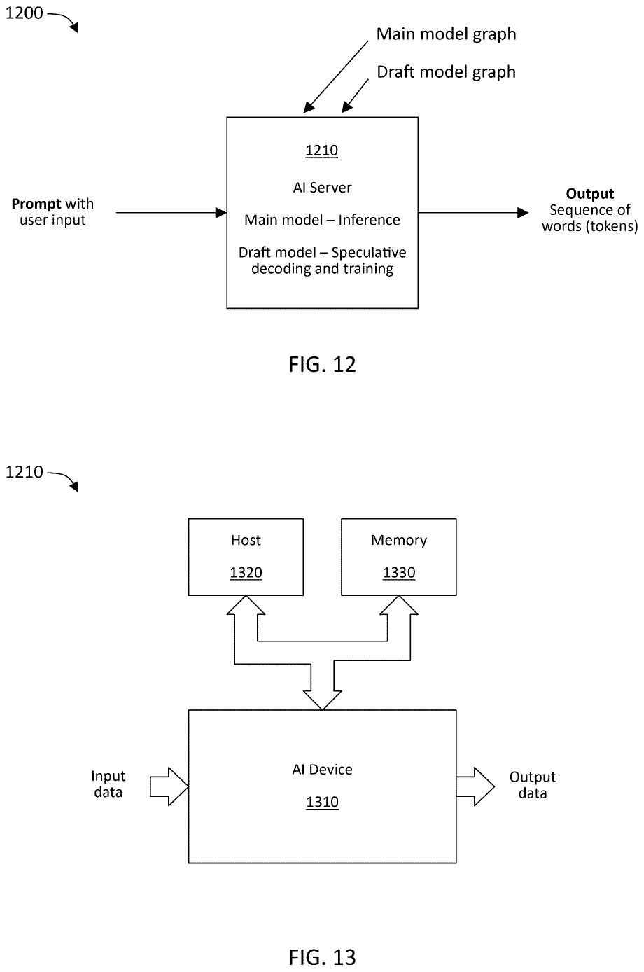

FIG. 12 illustrates an example system 1200 including an AI server 1210 operable to run inference on a main model and to perform speculative decoding and training using a draft model. The main model may be a large artificial intelligence (AI) model, for example a large language model (LLM) with over 400 billion parameters. The draft model may be much smaller than the main model and have, for example, only 8 billion parameters. Because it has many more parameters, the main model may be more accurate but also slower than the draft model. Its operation is relatively expensive in terms of runtime, hardware use, and power use. AI server 1210 may receive user input that includes a sequence of input tokens, and produce output that includes a sequence of output tokens, for example a sequence of six tokens T1, T2, . . . . T6. A token may be a word, or a part of a long word.

The performance of AI server 1210 may be measured with metrics such as the time-to-first-token (e.g., 0.1 seconds); the number of tokens per second (e.g., 30 tokens per second); and the utilization of the hardware (e.g., 10%).

One way to speed up AI server 1210 is by using speculative decoding. The main model is paired with the draft model, which predicts what the larger model is going to generate next. The draft model may have been trained on a smaller or different dataset, so there can be a disparity in acceptance rate. For example, the draft model may predict T′1, T′2, . . . . T′6. The implementation then passes the draft model's predicted tokens to the main model for verification. The main model can verify much quicker than it can generate, so the combined speed of the two models may go up from the example 30 tokens per second to, for example, 100 tokens per second. For its output, AI server 1210 keeps good results (tokens that were verified correct) but replaces any token after an incorrect result.

For example, if T′1 equals T1 and T′2 equals T2 but T′3 does not equal T3, then the implementation replaces tokens T′3 . . . . T′6.

To address and reduce inaccuracies of the draft model, the implementation may use both good and bad results to train and improve the draft model. It can perform training on-the-fly (this may also be called online training), or when the overall utilization of the hardware is low, e.g. at dinnertime or overnight.

Some implementations perform on-the-fly training using hardware that has local storage (memory) with each neural net in a neural network, allowing the hardware to instantaneously swap between a configuration for the main model and a configuration for the draft model, where the configurations may include a set of weight parameters for each neural net, a bias, parameters for functions to perform on a weighted sum of input signals, an activation function, and destinations for output signals.

Some implementations may store one or more graphs that define the model. Other implementations store one or more sequences of instructions that define the model. Yet other implementations store both one or more graphs and one or more sequences of instructions that define the model.

Some implementations store both the main model and the draft model in a single AI server, whereas other implementations store the main model in a first AI server and the draft model in a second AI server.

FIG. 13 illustrates an example of AI server 1210. AI server 1210 includes AI device 1310, which may be or include a coarse-grained reconfigurable architecture (CGRA), a graphics processing unit (GPU), a tensor processing unit (TPU), a language processing unit (LPU), or any other AI accelerator. AI server 1210 further includes a host 1320 and a memory 1330. Host 1320 may be or include a conventional computer architecture with user interface(s) and a program memory, or a processor architecture. Host 1320 controls the overall operation of AI server 1210, and may load and unload models in AI device 1310, control whether they are used for training or inference, and may generally control or execute the methods disclosed herein. Memory 1330 may be a shared memory for data, models, and training results. Both AI device 1310 and host 1320 may directly access memory 1330. Memory 1330 may include high-bandwidth memory (HBM), static random-access memory (SRAM), dynamic random-access memory (DRAM), non-volatile memory (NVM), flash memory, magnetic memory, and read-only memory (ROM). In some implementations, AI server 1210 includes multiple AI devices 1310.

An implementation may store part of a model in a single AI device 1310, part of multiple models, a full model, multiple full models, or any combination of full models and partial models. The implementation may store one model in one AI device 1310 and another model in another AI device 1310 so that host 1320 can operate the two models in parallel. The implementation may store two models in one AI device 1310 and switch between them on the fly, as explained above. An implementation may store two models in multiple AI devices 1310, each AI device 1310 storing two or more partial models, and switch between the two models on the fly, as explained above.

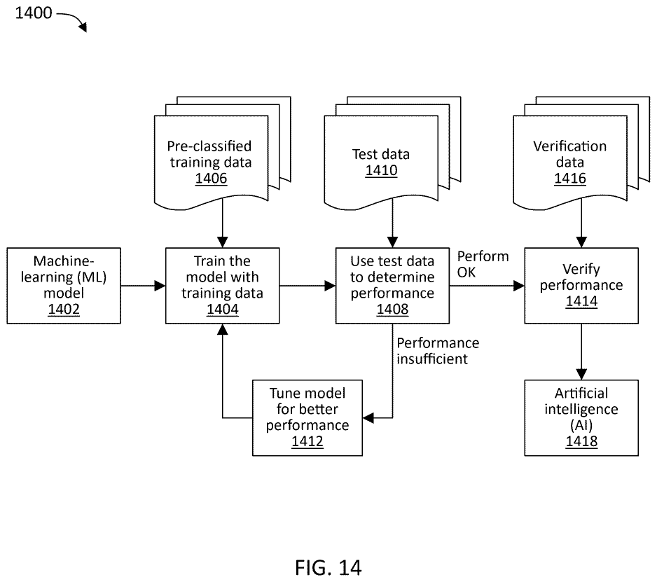

FIG. 14 is a flowchart of an example process 1400 to train a machine learning model, according to some implementations. For example, process 1400 may be performed during a training phase.

At 1402, a machine learning model (e.g., software code or a neural network architecture with weights or parameters) may be created by one or more designers. At 1404, the machine learning model may be trained using pre-classified training data 1406. For example, training data 1406 may have been pre-classified by humans, by automated processes, by machine learning, or a combination of those. Training may include backpropagation of errors to update weights or parameters; addition or elimination of connections between neurons; expansion or reduction of the number of neuron layers; and/or any other techniques known in the art.

After the machine learning model has been trained using the pre-classified training data 1406, the machine learning model may be tested, at 1408, using test data 1410 to determine a performance metric of the machine learning. The performance metric may include, for example, precision, recall, Frechet Inception Distance (FID), or a more complex performance metric. For example, in the case of a classifier, the accuracy of the classification may be determined using test data 1410.

If the performance metric of the model does not meet a desired level (e.g., an accuracy of 95%, 98%, 99%), at 1408, then the model and/or its parameters may be tuned, at 1412, to achieve a better performance. For example, at 1412, the designers may modify the machine learning model to improve its performance. After the machine learning model has been tuned, at 1412, the model may be retrained, at 1404, using the pre-classified training data 1406. In this way, 1404, 1408, and 1412 may be repeated until the performance of the model satisfies the desired performance metric. For example, in the case of a classifier, the classifier may be tuned to classify the test data 1410 with the desired accuracy.

After determining, at 1408, that the performance of the machine learning satisfies the desired performance metric, the process may proceed to 1414, where verification data 1416 may be used to verify the performance of the machine learning. After the performance of the machine learning is verified, at 1414, the machine learning algorithm 1402, which has been trained to provide a particular level of performance, may be used as an artificial intelligence (AI 1418). For example, the AI 1418 may include any AI model described herein.

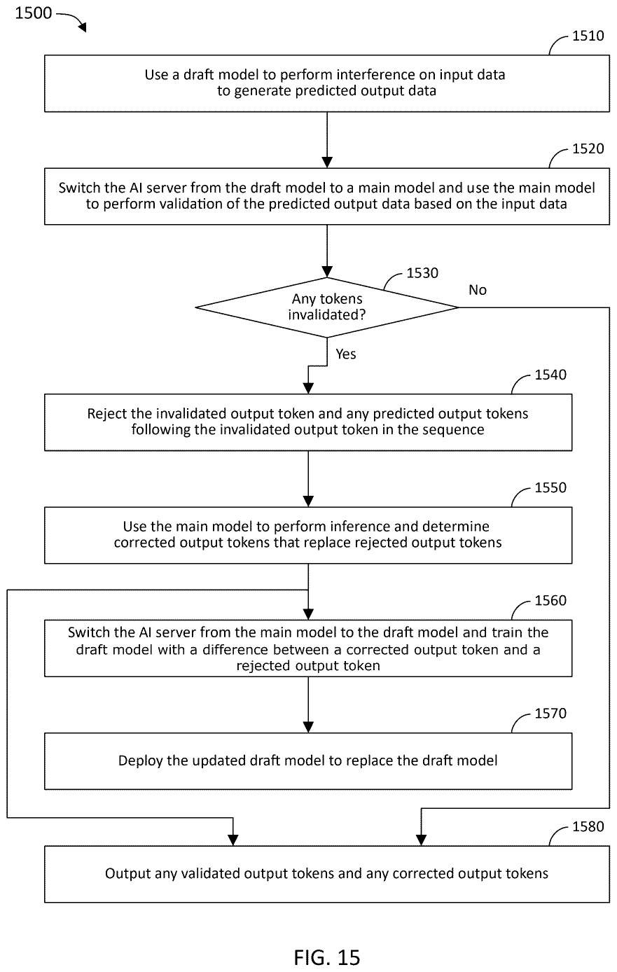

FIG. 15 illustrates a method 1500 of using and updating a draft model that performs speculative decoding. Method 1500 may be executed on a compute device (such as a processor, a computer, or an AI server, for example, AI server 1210), and comprises:
1510—using a draft model to perform inference on input data to generate predicted output data, the input data including a sequence of input tokens and the predicted output data including a sequence of predicted output tokens.
1520—Switching from the draft model to a main model and using the main model to perform validation of the predicted output data based on the input data, to classify predicted output tokens as validated output tokens or rejected output tokens.
1530—Determining if any predicted output token is rejected. In response to determining that a predicted output token is rejected, proceeding with 1540. In response to determining that no predicted output token is rejected, proceeding with 1580.
1540—(Optional) Classifying any predicted output tokens following a rejected output token as rejected output tokens.
1550—Using the main model to perform inference and determine corrected output tokens that replace rejected output tokens. Method 1500 may proceed with both 1560 and 1580, in parallel or one after the other in any order.
1560—Switching from the main model to the draft model and training the draft model with a difference between a corrected output token and a rejected output token to obtain an updated draft model.
1570—Deploying the updated draft model to replace the draft model.
1580—Outputting any validated output tokens and any corrected output tokens.

If the compute device comprises an AI server, it may include a host (e.g., computer 200), one or more AI devices, and a shared memory. The one or more AI devices may include at least a part of a network of configurable neurons. A neuron may include a local memory configured to store a first set of neuron configuration data, related to the main model, and a second set of neuron configuration data, related to the draft model. The neuron may be configured to switch at runtime between the first set of neuron configuration data and the second set of neuron configuration data.

An AI device may include a dataflow architecture, a coarse-grained reconfigurable architecture (CGRA), a graphics processing unit (GPU), a tensor processing unit (TPU), a language processing unit (LPU), and/or any other type of AI accelerator.

An implementation may store part of a model in a single AI device, part of multiple models, a full model, multiple full models, or any combination of full models and partial models. The implementation may store one model in one AI device and another model in another AI device so that the host can operate the two models in parallel. The implementation may store two models in one AI device and switch between them on the fly (i.e., at runtime), as explained above. An implementation may store two models in multiple AI devices, each AI device storing two or more partial models, and switch between the two models on the fly, as explained above.

The main model and/or the draft model may be specified in one or more graphs. Part or all of a compute device may be configured according to at least a part of the one or more graphs. Alternatively, the main model and/or the draft model may be specified in one or more sequences of instructions. Part or all of a compute device may be configured according to at least a part of the one or more sequences of instructions. Yet alternatively, a first part of the main model and/or a first part of the draft model may be specified in one or more graphs and at least a first part of the compute device is configured according to at least a first part of the one or more graphs. A second part of the main model and/or a second part of the draft model may be specified in one or more sequences of instructions and at least a second part of the compute device may be configured to load and execute at least a second part of the one or more sequences of instructions.

An implementation may train the draft model on the fly, as validated output tokens, rejected output tokens, and corrected output tokens become available.

An implementation may train the draft model (with the difference between the corrected output token and the rejected output token) at a scheduled time when low-volume inference is expected. Alternatively, or in addition, the implementation may train the draft model automatically when the inference volume is low.

When none of the predicted output tokens is rejected, the implementation may perform reinforcement training of the draft model using the sequence of predicted output tokens.

In some implementations, a non-transitory computer-readable storage medium comprising configurations and/or instructions. When loaded on or executed by a compute device, these cause the compute device to perform method 1500. In further implementations, an AI server comprises a host including one or more processors, a memory, an AI device, and logic encoded in one or more tangible non-transitory media for execution by the one or more processors. When executed, the logic is operable to perform method 1500.

### CONSIDERATIONS

We describe various implementations of a method of ongoing updating a draft AI model. The method is configured and executed on an AI server, which may include a host, a memory, and an AI device.

The technology disclosed may implement apparatuses and methods. One or more features of an implementation can be combined with the base implementation.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the implementations described herein.

Although the description has been described with respect to specific implementations thereof, these specific implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to specific implementations thereof, these specific implementations are merely illustrative, and not restrictive. For instance, many of the operations can be implemented on a printed circuit board (PCB) using off-the-shelf devices, in a System-on-Chip (SoC), application-specific integrated circuit (ASIC), programmable processor, a coarse-grained reconfigurable architecture (CGRA), or in a programmable logic device such as a field-programmable gate array (FPGA), obviating the need for at least part of any dedicated hardware. Implementations may be as a single chip, or as a multi-chip module (MCM) packaging multiple semiconductor dies in a single package. All such variations and modifications are to be considered within the ambit of the disclosed technology the nature of which is to be determined from the foregoing description.

Any suitable programming language can be used to implement the routines of specific implementations including Python, C, C++, Java, JavaScript, compiled languages, interpreted languages and scripts, assembly language, machine language, etc. Different programming techniques can be employed such as procedural or object oriented. Methods embodied in routines can execute on a single processor device or on a multiple processor system. Although the steps, operations, or computations may be presented in a specific order, this order may be changed in different specific implementations. In some specific implementations, multiple steps shown as sequential in this specification can be performed at the same time.

Specific implementations may be implemented in a tangible, non-transitory computer-readable storage medium for use by or in connection with the instruction execution system, apparatus, board, or device. Specific implementations can be implemented in the form of control logic in software or hardware or a combination of both. The control logic, when executed by one or more processors, may be operable to perform that which is described in specific implementations. For example, a tangible non-transitory medium such as a hardware storage device can be used to store the control logic, which can include executable instructions.

One or more implementations of the technology or elements thereof can be implemented in the form of a computer product, including a non-transitory computer-readable storage medium with computer usable program code for performing any indicated method steps and/or any configuration file for one or more CGR processors to execute a high-level program. Furthermore, one or more implementations of the technology or elements thereof can be implemented in the form of an apparatus including a memory and at least one processor that is coupled to the memory and operative to perform exemplary method steps, and/or a CGR processor that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

It will also be appreciated that one or more of the elements depicted in the drawings/figures can also be implemented in a more separated or integrated manner, or even removed or rendered as inoperable in certain cases, as is useful in accordance with a particular application.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material to the essential scope and spirit.

What is claimed is:

1. A compute-device-implemented method of updating an artificial intelligence (AI) draft model, comprising:
using the draft model, performing inference on input data to generate predicted output data, the input data including a sequence of input tokens and the predicted output data including a sequence of predicted output tokens;
using a main model, validating the predicted output data based on the input data to classify predicted output tokens as validated output tokens or rejected output tokens;
determining if any of the predicted output tokens is a rejected output token;
in response to determining that any of the predicted output tokens is a rejected output token:
using the main model to perform inference and determine corrected output tokens to replace the rejected output token(s);
outputting validated output tokens and corrected output tokens;
training the draft model with a difference between a corrected output token and a rejected output token to obtain an updated draft model; and
deploying the updated draft model to replace the draft model; and
in response to determining that none of the predicted output tokens is a rejected output token:
outputting the validated output tokens.

2. The method of updating the draft model of claim 1, wherein in response to determining that any of the predicted output tokens is a rejected output token further comprises classifying a predicted output token that follows a rejected output token as a rejected output token.

3. The method of updating the draft model of claim 1, wherein the compute device comprises an AI server including a host, one or more AI devices, and a shared memory.

4. The method of updating the draft model of claim 3, wherein at least a part of the main model and at least a part of the draft model are configured on the one or more AI devices, and wherein the one or more AI devices include at least a part of a network of configurable neurons, a neuron including a local memory configured to store a first set of neuron configuration data, related to the main model, and a second set of neuron configuration data, related to the draft model, and wherein the neuron is configured to switch at runtime between the first set of neuron configuration data and the second set of neuron configuration data.

5. The method of updating the draft model of claim 3, wherein training the draft model with the difference between the corrected output token and the rejected output token to obtain the updated draft model is scheduled at a time of low-volume inference.

6. The method of updating the draft model of claim 3, wherein training the draft model with the difference between the corrected output token and the rejected output token to obtain the updated draft model is performed automatically when an inference volume is low.

7. The method of updating the draft model of claim 3, wherein one of the one or more AI devices includes at least one of a dataflow architecture, a coarse-grained reconfigurable architecture (CGRA), a graphics processing unit (GPU), a tensor processing unit (TPU), a language processing unit (LPU), or an AI accelerator.

8. The method of updating the draft model of claim 1, wherein the main model and/or the draft model is specified in one or more graphs and at least a part of the compute device is configured according to at least a part of the one or more graphs.

9. The method of updating the draft model of claim 1, wherein the main model and/or the draft model is specified in one or more sequences of instructions and at least a part of the compute device is configured to load and execute at least a part of the one or more sequences of instructions.

10. The method of updating the draft model of claim 1, wherein a first part of the main model and/or a first part of the draft model is specified in one or more graphs and at least a first part of the compute device is configured according to at least a first part of the one or more graphs, and wherein a second part of the main model and/or a second part of the draft model is specified in one or more sequences of instructions and at least a second part of the compute device is configured to load and execute at least a second part of the one or more sequences of instructions.

11. The method of updating the draft model of claim 1, wherein in response to determining that none of the predicted output tokens are rejected output tokens further includes performing reinforcement training of the draft model using the sequence of predicted output tokens.

12. An AI server comprising:
a host including one or more processors;
a memory;
an AI device; and
logic encoded in one or more tangible non-transitory media for execution by the one or more processors and when executed operable to:
using a draft model, perform inference on input data to generate predicted output data, the input data including a sequence of input tokens and the predicted output data including a sequence of predicted output tokens;
using a main model, validate the predicted output data based on the input data to classify predicted output tokens as validated output tokens or rejected output tokens;
determine if any of the predicted output tokens are rejected output tokens;
in response to determining that any of the predicted output tokens are rejected output tokens:
use the main model to perform inference and determine corrected output tokens to replace the rejected output tokens;
output validated output tokens and corrected output tokens;
train the draft model with a difference between a corrected output token and a rejected output token to obtain an updated draft model; and
deploy the updated draft model to replace the draft model; and
in response to determining that none of the predicted output tokens are rejected output tokens:
output the validated output tokens.

13. A non-transitory computer-readable storage medium comprising configurations and/or instructions which, when loaded on or executed by a compute device, cause the compute device to:
using a draft model, perform inference on input data to generate predicted output data, the input data including a sequence of input tokens and the predicted output data including a sequence of predicted output tokens;
using a main model, validate the predicted output data based on the input data to classify predicted output tokens as validated output tokens or rejected output tokens;
determine if any of the predicted output tokens are rejected output tokens;
in response to determining that any of the predicted output tokens are rejected output tokens:
use the main model to perform inference and determine corrected output tokens to replace the rejected output tokens;
output validated output tokens and corrected output tokens;
train the draft model with a difference between a corrected output token and a rejected output token to obtain an updated draft model; and
deploy the updated draft model to replace the draft model; and
in response to determining that none of the predicted output tokens are rejected output tokens:
output the validated output tokens.
